(19) United States
(12) Patent Application Publication
(10) Pub. No.: US 2025/0270473 A1
(43) Pub. Date: Aug. 28, 2025

(54) COMPOSITIONS, METHODS AND USES

(71) Applicant: INNOSPEC LIMITED, Cheshire (GB)

(72) Inventors: Alessandra ANDREOLI, Castiglione delle Stiviere (IT); Massimo MOR, Castiglione delle Stiviere (IT); Francesco MAZZANTI, Castiglione delle Stiviere (IT)

(21) Appl. No.: 18/857,885

(22) PCT Filed: Apr. 17, 2023
(86) PCT No.: PCT/GB2023/051016

§ 371 Date: Oct. 18, 2024

(30) Foreign Application Priority Data
Apr. 19, 2022 (GB) 2205711.1

(51) Int. Cl. C11D 1/40; C11D 1/46; C11D 1/86; C11D 1/90; C11D 1/94; C11D 3/43; C11D 17/00

(52) U.S. Cl. CPC C11D 1/40; C11D 1/46; C11D 1/86; C11D 1/90; C11D 1/94; C11D 3/43; C11D 17/0073; C11D 17/0095

(57) ABSTRACT

A solid detergent composition comprising: (a) a salt of an amine and a fatty acid wherein at least 50% of the fatty acid molecules have at least 16 carbon atoms; (b) at least one nitrogen containing surfactant; (c) at least one anionic surfactant; (d) at least one solvent including at least one hydroxy functional group; and (c) water; wherein water makes up no more than 20 wt % of the total detergent composition.

The present invention relates to detergent compositions. In particular the invention relates to unit dose compositions having improved properties for use in toilet care, automatic dishwashing, manual dishwashing, laundry, fabric care, kitchen care, carpet cleaning, air fresheners, vehicle care, polishing products, machine cleaning and maintenance, pesticides, insecticides, fungicides, herbicides, oilfield chemical applications, marine applications, personal care and institutional/industrial cleaning. The detergent compositions may be especially useful in household cleaning applications, for example in laundry detergent compositions.

Detergent compositions are commonly known for household use, particularly for laundry and automatic dishwashing applications. Compositions may be provided in loose powder or liquid form where a user measures out a dose each time before use.

Many consumers prefer to buy detergent compositions in unit dose form in which the dose is pre-measured and a single tablet or pouch is added to the washing machine or dishwasher. Unit dose detergent compositions are often provided in the form of compressed powder tablets or pouches comprising liquids encapsulated in a water-soluble polymer.

The nature of the ingredients in many compositions means that the unit doses must be individually wrapped in a disposable packaging or encased in a polymer. In some embodiments pouches or tablets include multiple compartments. This is typically to separate incompatible ingredients so that they do not react and degrade on storage.

A number of factors are important in the design of unit doses. When a liquid, compressed powder or a mixture thereof is enclosed or encapsulated within a tablet or pouch the outer material must dissolve quickly to release the contents when in use. However it must not easily degrade or rupture during storage.

Wrapping or encapsulating tablets adds to the complexity and cost of manufacture, as does the inclusion of multiple compartments in a tablet or pouch. Also, such products have been known to rupture when handled by children leading to exposure of the child to harmful detergents and therefore potentially less safe than completely solid detergent products.

It would therefore be highly desirable to provide a unit dose detergent in a solid easy to handle form, preferably not encased or encapsulated in a polymer and which does not need individual protective wrappings.

Environmental concerns are becoming increasingly important and it is highly desirable to provide a unit dose form that could be provided in plastic-free packaging.

In order to reduce the environmental impact of detergents it is also preferable to provide compositions in concentrated form to avoid the unnecessary transportation of water. Thus compositions having low water levels are highly desirable.

A detergent composition also needs to be aesthetically pleasing and attractive to consumers. Transparent compositions are considered desirable.

A further challenge in the manufacture of unit doses compared with bulk liquid or powder compositions is to provide a composition which has good dissolution characteristics.

Also important in the manufacture of detergents is the safety of the components used, with skin and ocular irritancy reduced as much as possible.

It is an aim of the present invention to provide a novel detergent composition which overcomes at least one disadvantage of the prior art whether stated herein or otherwise.

According to a first aspect of the present invention there is provided a solid detergent composition comprising:
(a) a salt of an amine and a fatty acid wherein at least 50% of the fatty acid molecules have at least 16 carbon atoms;
(b) at least one nitrogen containing surfactant;
(c) at least one anionic surfactant;
(d) at least one solvent including at least one hydroxy functional group; and
(e) water;
   wherein water makes up no more than 20 wt % of the total detergent composition.

The solid detergent composition comprises (a) a salt of an amine and a fatty acid wherein at least 50% of the fatty acid molecules have at least 16 carbon atoms.

The amine is preferably a primary amine, i.e. the amine preferably includes an NH₂ functional group.

Suitably the amine has 3 to 20 carbon atoms, preferably 3 to 12 carbon atoms, for example 3 to 6 carbon atoms, 3 to 5 carbon atoms or 3 to 4 carbon atoms. Most preferably the amine has 3 carbon atoms.

Preferably the amine is an alkanolamine. The amine may be monoalkanolamine, a dialkanolamine, a trialkanolamine, an N-alkyl alkanolamine or an N-hydroxyalkyl alkanolamine. Suitable N-alkyl alkanolamines are methyl alkanolamines. Suitable N-hydroxyalkyl alkanolamines are N-hydroxymethyl alkanolamines. Preferably the amine is a monoalkanolamine.

Preferably the hydroxy group of the monoalkanolamine is not joined to a terminal carbon atom.

Most preferably the amine is monoisopropanolamine, i.e. the compound of formula CH₃CH(OH)CH₂NH₂.

Component (a) comprises the salt of an amine and a fatty acid. Although reference is made to a fatty acid, it will be understood that this material may comprise a mixture of components. At least 50% of the fatty acid molecules have at least 16 carbon atoms.

The fatty acid may comprise a mixture of compounds, typically a mixture of isomers and/or homologues.

The skilled person will appreciate that natural sources of fatty acids often contain mixtures.

The present inventors have surprisingly found that when using fatty acid salts in the present invention at least 50% of the fatty acid molecules must have at least 16 carbon atoms in order to achieve beneficial properties. This feature is defined in terms of the number of fatty acid molecules present in component (a) and their number of carbons. Therefore in order to determine whether a fatty acid mixture has at least 50% of fatty acid molecules having at least 16 carbon atoms, molar ratios of each fatty acid present should be used. For the avoidance of doubt, weight ratios of the fatty acids present should not be used to determine whether a fatty acid mixture has at least 50% of fatty acid molecules having at least 16 carbon atoms.

Suitably the fatty acid comprises compounds of formula RCOOH wherein R is an optionally substituted alkyl or alkenyl group. Preferably R is an unsubstituted alkyl or alkenyl group. In preferred embodiments R is an alkyl group.

Preferred fatty acids are saturated fatty acids.

The fatty acid may comprise some unsaturated components but predominantly saturated compounds are preferred. Suitably at least 50% of the fatty acid molecules saturated, suitably at least 75% or at least 90%. Preferably all or substantially all of the fatty acid molecules are saturated.

At least 50% of the fatty acid molecules have at least 16 carbon atoms. Fatty acid components having fewer than 16 carbon atoms, for example fatty acids having 12 carbon atoms may be included but these are present in a total amount of less than 50 mol %. Natural sources comprising C12 fatty acids, such as coconut fatty acid may be included.

At least 50% of the fatty acid molecules have at least 16 carbon atoms. Preferred are fatty acids having 16 to 30 carbon atoms, preferably 16 to 24 carbon atoms, more preferably 16 to 20 carbon atoms, most preferably 16 to 18 carbon atoms.

In especially preferred embodiments at least 80%, preferably at least 90% of the fatty acid molecules have 16 to 18 carbon atoms.

Preferably at least 90% of the fatty acid molecules are saturated C16 to C18 fatty acids.

In especially preferred embodiments the fatty acid comprises an approximately equimolar mixture of C16 and C18 saturated fatty acids.

Component (a) preferably comprises the monoisopropanolamine salt of a mixture of C16 and C18 fatty acids.

The components (a), (b) and (c) of the solid detergent composition of this first aspect are suitably provided by different components. Although component (a) may be considered to be a nitrogen-containing surfactant and/or an anionic surfactant, the salt of an amine and a fatty acid wherein at least 50% of the fatty acid molecules have at least 16 carbon atoms provides only component (a) of the solid detergent composition. Therefore the solid detergent composition comprises one or more nitrogen containing surfactant component (b) which is/are different to component (a) and one or more anionic surfactant component (c) which is/are different to component (a) and component (b).

Component (b) comprises at least one nitrogen containing surfactant.

Component (b) may comprise a mixture of two or more nitrogen containing surfactants.

Any suitable nitrogen containing surfactant may be used and suitable surfactant compounds will be known to the person skilled in the art.

Preferably component (b) comprises one or more nitrogen containing surfactants selected from alkanolamides, amine oxides and amphoteric or zwitterionic compounds, or mixtures thereof.

In some embodiments component (b) comprises an alkanolamide.

In some embodiments component (b) comprises an amine oxide.

In some embodiments component (b) comprises an amphoteric or zwitterionic nitrogen containing surfactant, preferably a betaine.

In some embodiments, component (b) comprises a betaine.

In some embodiments component (b) comprises a betaine and an alkanolamide.

In some embodiments, component (b) comprises an alkanolamide, an amine oxide and a betaine.

In preferred embodiments, component (b) comprises a betaine and an amine oxide.

In preferred embodiments, component (b) comprises an amine oxide and an alkanolamide.

By alkanolamide we mean to refer to the reaction product of an alkanolamine and a fatty acid donor (for example a fatty acid, a fatty acid ester or a triglyceride). The alkanolamide may be referred to as a fatty acid alkanolamide. The reaction product of a fatty acid and alkanolamine suitably mainly contains the fatty acid alkanolamide. The reaction product may contain some ester compound formed by the fatty acid and the alkanolamine. Therefore the reaction product of the fatty acid and the alkanolamine may be a mixture of fatty acid alkanolamide and fatty acid amino ester.

The alkanolamide may be prepared from a monoalkanolamine or a dialkanolamine.

Preferably the alkanolamide is prepared from a monoalkanolamine.

In some embodiments the alkanolamide is prepared from a dialkanolamine.

Preferably the alkanolamide comprises the reaction product of a fatty acid donor and an alkanolamine selected from monoethanolamine, monopropanolamine, monoisopropanolamine monobutanolamine and diethanolamine.

Preferably the alkanolamide comprises the reaction product of a fatty acid donor and monoisopropanolamine. Therefore the alkanolamide is suitably a fatty acid alkanolamide comprising a fatty acid moiety.

Suitably the fatty acid moiety has the formula RC(O)— wherein R is an optionally substituted alkyl, hydroxyalkyl, alkenyl or hydroxyalkenyl group, for example hydroxystearic acid group. Preferably R is an unsubstituted alkyl or alkenyl group. In preferred embodiments R is an alkyl group.

Preferably R is an alkyl or alkenyl group having 6 to 36 carbon atoms, preferably 6 to 30 carbon atoms, more preferably 8 to 24 carbon atoms, for example 10 to 20 carbon atoms.

In some preferred embodiments the fatty acid moiety comprises predominantly C12 fatty acids.

The skilled person will appreciate that natural sources of fatty acids typically comprise mixtures of compounds.

Preferably the fatty acid moiety is coconut fatty acid. In such embodiments, the alkanolamide may be formed by the reaction of a coconut fatty acid ester with an alkanolamine.

Preferably the alkanolamide is formed by the reaction of a coconut fatty acid ester with monoisopropanolamine.

Suitably the alkanolamide has the formula:

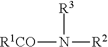

wherein R¹ is an alkyl, alkenyl hydroxyalkyl and hydroxyalkenyl containing 6 to 22 carbon atoms, R² is a hydroxyalkyl group containing 2, 3, 4, 5 or 6 carbon atoms, and R³ is hydrogen or an alkyl group or has the same meaning as R². Preferably, R² is a hydroxyisopropyl group, in which case the molecule can be referred to as an alkanoyl isopropanol amide. Preferably R³ is hydrogen.

Suitable examples of such fatty acid alkanolamides are Cocamide MIPA (i.e. EMPILAN® CIS), Cocamide MEA (i.e. EMPILAN® CME/T), Cocamide DEA (i.e. EMPILAN® 2502), Cocamide methyl MEA, Lauramide MEA, Lauramide DEA, Lauramide MIPA, Myristamide MEA, Myristamide DEA, Myristamide MIPA, Stearamide MEA, Stearamide DEA, Stearamide MIPA, Hydroxystearamide MEA, Isostearamide DEA, N-Tris(hydroxymethyl) methyl lauramide, Oleamide MEA, Oleamide DEA; Oleamide MIPA, Soyamide MEA, Soyamide DEA, Soyamide MIPA, Behenamide MEA, Behenamide DEA, Palmitamide MEA, Palmitamide DEA, Ricinoleamide MEA, Ricinoleamide DEA, Ricinoleamide MIPA, Tallowamide MEA, Tallowamide DEA, Undecylenamide MEA, Undecylenamide DEA, N-Lauroyl-N-methylglucamide, N-Cocoyl-N-methylglucamide or a mixture thereof.

Most preferably component (b) comprises cocamide MIPA.

Preferred amine oxides for use herein are oxides of tertiary amines. Preferably the amine oxide is an oxide of an tertiary alkylamine or alkenylamine having 6 to 36 carbon atoms, preferably 6 to 30 carbon atoms, more preferably 8 to 24 carbon atoms, for example 10 to 20 carbon atoms.

Preferably the amine oxide is an oxide of a tertiary alkylamine. The amine oxide may comprise a mixture of compounds, suitably a mixture of homologues. The skilled person will understand that amines obtained from natural sources typically comprise mixtures of compounds.

Preferably the amine oxide comprises a mixture of C12 to C₁₆ amine oxides.

In some embodiments component (b) comprises an amphoteric or zwitterionic nitrogen containing surfactant.

Amphoteric or zwitterionic nitrogen containing surfactants for use as component (b) in the compositions of the present invention may include those which have an alkyl or alkenyl group of 7 to 22 carbon atoms and comply with an overall structural formula:

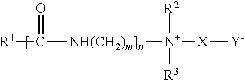

where R¹ is an alkyl or alkenyl group having 7 to 22 carbon atoms; R² and R³ are each independently alkyl, hydroxyalkyl or carboxyalkyl of 1 to 6 carbon atoms; m is 2 to 4; n is 0 or 1; X is alkylene of 1 to 6 carbon atoms optionally substituted with hydroxyl; and Y is —CO₂ or —SO₃.

Such amphoteric or zwitterionic nitrogen containing surfactants may comprise compounds of the above formula having different numbers of carbon atoms in the R¹ group, within the range of 7 to 22 carbon atoms. For example when the R¹ is derived from a natural source such as a coconut fatty acid derivative.

Surfactants suitable for use as component (b) may include simple betaines of formula:

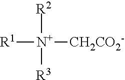

and amido betaines of formula:

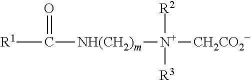

where m is 2 or 3.

In both formulae R¹, R² and R³ are as defined previously. R¹ may, in particular, be a mixture of C12 and C14 alkyl groups derived from coconut so that at least half, preferably at least three quarters, of the groups R¹ has 10 to 14 carbon atoms. R² and R³ are preferably methyl.

In some preferred embodiments, R¹ may be a C8 alkyl group so that at least half, preferably at least three quarters, of the groups R¹ has 8 carbon atoms. R² and R³ are preferably methyl.

In some preferred embodiments, R¹ may be a C10 alkyl group so that at least half, preferably at least three quarters, of the groups R¹ has 10 carbon atoms. R² and R³ are preferably methyl.

In some preferred embodiments, R¹ may be a mixture of C8 and C10 alkyl groups so that at least half, preferably at least three quarters, of the groups R¹ has 8 to 10 carbon atoms. R² and R³ are preferably methyl.

Surfactant component (b) may include sultaines (or sulphobetaines) of formula:

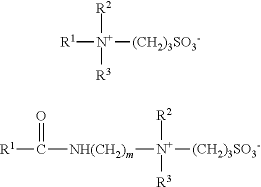

wherein m is 2 or 3, or variants of these in which
(CH₂)₃SO₃⁻ is replaced by

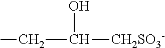

wherein R¹, R² and R³ in these formulae are as defined previously.

Surfactant component (b) may include amphoacetates and diamphoacetates. Amphoacetates generally conform to the following formula:

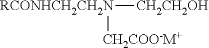

Diamphoacetates generally conform to the following formula:

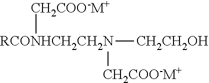

wherein R is an aliphatic group of 7 to 22 carbon atoms and M is a cation such as sodium, potassium, ammonium, or substituted ammonium.

Suitable acetate-based amphoteric surfactants include lauroamphoacetate; alkyl amphoacetate; cocoampho(di)acetate; cocoamphoacetate; disodium cocoamphodiacetate; sodium cocoamphoacetate; disodium cocoamphodiacetate; disodium capryloamphodiacete; disodium lauroamphoacetate; sodium lauroamphoacetate and disodium wheatgerm amphodiacetate.

Suitable betaine surfactants include alkylamido betaine; alkyl betaine, C_{12/14} alkyldimethyl betaine; cocoamidopropylbetaine; tallow bis(hydroxyethyl) betaine; hexadecyldimethylbetaine; cocodimethylbetaine; alkyl amido propyl sulfo betaine; alkyl dimethyl amine betaine; coco amido propyl dimethyl betaine; alkyl amido propyl dimethyl amine betaine; cocamidopropyl betaine; lauryl betaine; laurylamidopropl betaine, coco amido betaine, lauryl amido betaine, alkyl amino betaine; alkyl amido betaine; coco betaine; lauryl betaine; diemethicone propyl PG-betaine; oleyl betaine; N-alkyldimethyl betaine; coco biguamide derivative, C8 amido betaine; C12 amido betaine; lauryl dimethyl betaine; alkylamide propyl betaine; amido betaine; alkyl betaine; cetyl betaine; oleamidopropyl betaine; isostearamidopropyl betaine; lauramidopropyl betaine; 2-alkyl-N-carboxymethyl-N-hydroxyethyl imidazolinium betaine; 2-alkyl-N-carboxyethyl-N-hydroxyethyl imidazolinium betaine; 2-alkyl-N-sodium carboxymethyl-N-carboxymethyl oxyethyl imidazolinium betaine; N-alkyl acid amidopropyl-N,N-dimethyl-N-(3-sulfopropyl)-ammonium-betaine; N-alkyl-N,N-dimethyl-N-(3-sulfopropyl)-ammonium-betaine; cocodimethyl betaine; apricotamidopropyl betaine; isostearamidopropyl betaine; myristamidopropyl betaine; palmitamidopropyl betaine; cocamidopropyl hydroxyl sultaine; undecylenamidopropyl betaine; cocoamidosulfobetaine; alkyl amido betaine; C12/18 alkyl amido propyl dimethyl amine betaine; lauryldimethyl betaine; ricinol amidobetaine; tallow aminobetaine; octyl amidopropyl betaine; decyl amidopropyl betaine; C8 amidopropyl betaine; C10 amidopropyl betaine; C8-C10 amidopropyl betaine and C12-C18 amidopropyl betaine.

Suitable glycinate-based amphoteric surfactants include cocoamphocarboxyglycinate; tallowamphocarboxygycinate; capryloamphocarboxyglycinate, oleoamphocarboxyglycinate, bis-2-hydroxyethyl tallow glycinate; lauryl amphoglycinate; tallow polyamphoglycinate; coco amphoglycinate; oleic polyamphoglycinate; N—C_{10/12} fatty acid amidoethyl-N-(2-hydroxyethyl)-glycinate; N—C_{12/18}-fatty acid amidoethyl-N-(2-hydroxyethyl)-glycinate and dihydroxyethyl tallow glycinate.

Preferred acetate-based amphoteric surfactants for use as component (b) include sodium lauroamphocaetate, disodium lauroamphoacetate and mixtures thereof.

Preferred betaine surfactants for use as component (b) are amido betaines. Especially preferred compounds include cocoamidopropyl betaine and amidopropyl betaines prepared from C8 and/or C10 fatty acids.

Preferably component (b) comprises one or more of: the reaction product of a fatty acid having 8 to 20 carbon atoms and a monoalkanolamine; an amine oxide having 8 to 20 carbon atoms; and an amido betaines prepared from C6 to C20 fatty acids.

Component (c) comprises at least one anionic surfactant.

Component (c) may comprise a mixture of two or more anionic surfactants.

Any suitable anionic surfactant may be included. Such compounds will be known to the person skilled in the art.

Suitable anionic surfactants for use herein include salts of: fatty acids; alkoxylated carboxylic acids; ester carboxylates; ethoxylated ester carboxylates; mono- or dialkyl sulfates; mono- or dialkyl ether sulfates; lauryl ether sulfates; alkyl sulfonates; alkyl aryl sulfonates; primary alkane disulfonates; alkene sulfonates; hydroxy alkane sulfonates; isethionates, alkyl isethionates, acyl isethionates, acyl alkyl isethionates, alkyl glyceryl ether sulfonates; alpha-olefin sulfonates; alkyl phosphates; sulfonates of alkylphenolpolyglycol ethers; alkyl sulfopolycarboxylic acid esters; alkyl sulfosuccinates; alkyl ether sulfosuccinates; taurates; acyl taurates; products of condensation of fatty acids with oxy- and aminoalkanesulfonic acids; sulfated derivatives of fatty acids and polyglycols; alkyl and acyl sarcosinates; sulfoacetates; alkyl phosphates; alkyl phosphate esters; acyl lactates; alkanolamides of sulfated fatty acids, lipoamino acids and acyl substituted amino acids, for example acyl glycinates and acyl glutamates. Particularly exemplary salts, where applicable, are the sodium, potassium, ammonium, magnesium and triethanolamine salts.

Preferred anionic surfactants include alkyl or alkenyl sulfates, alkyl or alkenyl ether sulfates, alkyl glyceryl ether sulfates, taurates, acyl taurates, (alkyl) isethionates (alkyl) acyl isethionates, acyl substituted amino acids, sarcosinates, sulfosuccinates, sulfosuccinamates, sulphoacetates, monoalkyl phosphate esters, di-alkyl phosphate esters, mono-alkyl ether phosphate esters, di-alkyl ether phosphate esters, alpha-olefin sulfonates, acyl lactates, alkyl ether carboxylates and glyceryl ether carboxylates.

Particularly preferred anionic surfactants for use herein include alkyl or alkenyl sulfates, alkyl or alkenyl ether sulfates, taurates, isethionates, acyl substituted amino acids, sarcosinates, and sulfosuccinates.

References herein to taurate surfactants or acyl taurates include compounds such as sodium lauroyl methyl taurate, sodium methyl cocoyl taurate and sodium methyl oleoyl taurate which could also be regarded as alkyl acyl taurates.

Illustrative examples of preferred anionic surfactants include sodium lauryl sulphate, sodium lauryl ether sulfate, sodium lauroyl methyl taurate, sodium methyl cocoyl taurate, sodium methyl oleoyl taurate, sodium cocoyl isethionate, sodium lauroyl isethionate, sodium cocoyl methyl isethionate, sodium lauroyl methyl isethionate, sodium lauroyl glycinate, sodium cocoyl glycinate, sodium lauryl sarcosinate, and disodium oleamido monoisopropanolamine (MIPA) sulfosuccinate.

Suitable alkyl or alkenyl sulfates and ether sulfates are compounds of formula:

R¹CH₂(OR²)ₙOSO₃M

wherein R¹ is a C5 to C39 alkyl or alkenyl group, R² is an alkylene group having 1 to 4 carbon atoms and n is from 0 to 12.

Preferably R¹ is a C7 to C15 alkyl or alkenyl group or a C9 to C13 alkyl or alkenyl group, suitably an alkyl group. For example, R¹ may be a C11 alkyl group.

R² is preferably a propylene or especially an ethylene moiety. Preferably n is from 0 to 6, preferably from 0 to 4, for example from 0 to 3. In some embodiments n is 0. In some embodiments n is 2. The skilled person will understand that alkyl or alkenyl ether sulfates typically contain mixtures of compounds with different n numbers due to the statistical nature of the alkoxylation reaction used in their formation. Some molecules are not alkoxylated in such a reaction and therefore some molecules wherein n=0 may be present, e.g. alkyl sulfate

In some preferred embodiments, n is 2 or 3, or a mixture of compounds wherein n is 2 and compounds wherein n is 3.

In some preferred embodiments, n is 1.

The above n numbers suitably represent an average n number of a mixture of such alkyl or alkenyl sulfates and ether sulfates.

Suitable anionic surfactants include salts of alkyl sulfates, alkyl ether sulfates, fatty acids, carboxylates, alkyl sulfonates, aryl sulfonates, alkyl benzene sulphonates, isethionates, alkyl phosphates, sulfosuccinates, taurates, sarcosinates, sulfoacetates, lactates, acyl amino acids and phosphonates.

Suitable anionic surfactants for use in laundry compositions of the present invention typically comprise one or more moieties selected from the group consisting of carbonate, phosphate, phosphonate, sulphate, sulphonate, carboxylate and mixtures thereof. The anionic surfactant may be one or mixtures of more than one of alkyl or alkenyl sulphates, alkyl or alkenyl ether sulphates, alkyl sulphonates, alkenyl sulphonates and hydroxyalkyl sulphonates. Preferred anionic surfactants include lauryl ether sulfates and taurates (including acyl taurates and alkyl acyl taurates). Particularly preferred anionic surfactants are lauryl ether sulfates.

Component (d) comprises at least one solvent including at least one hydroxy functional group.

Suitable such solvents include monohydric alcohols, polyhydric alcohols, alkoxy alcohols and aryloxy alcohol.

Suitable solvents are monohydric alcohols, polyhydric alcohols and alkoxy alcohols.

Preferred solvents are miscible with water.

Suitable simple monohydric alcohols include methanol, ethanol, isopropanol and butanol.

Preferably component (d) comprises a polyhydric alcohol or an alkoxyalcohol.

Suitable alkoxy alcohols include diethylene glycol monobutyl ether, 3-methoxy-3-methyl-1-butanol and 2-butoxyethanol.

One especially preferred alkoxy alcohol for use herein is 3-methoxy-3-methyl-1-butanol.

Suitable aryloxy alcohols include 2-phenoxyethanol.

Suitable polyhydric alcohols include glycerol, ethylene glycol, polyethylene glycol, propylene glycol, dipropylene glycol, polypropylene glycol and 2-methylpentanediol.

Suitable polyhydric alcohols include glycerol, ethylene glycol, polyethylene glycol, propylene glycol, dipropylene glycol and polypropylene glycol.

A mixture of propylene glycol and dipropylene glycol is especially preferred.

Preferably component (d) comprises propylene glycol, dipropylene glycol, 3-methoxy-3-methyl-1-butanol, 2-methylpentanediol, 2-phenoxyethanol or a mixture thereof.

In some embodiments, component (d) comprises propylene glycol and dipropylene glycol.

In some embodiments, component (d) comprises 3-methoxy-3-methyl-1-butanol and dipropylene glycol.

In some embodiments, component (d) comprises a mixture of propylene glycol and 2-phenoxyethanol.

In some embodiments, component (d) may comprise a second solvent in addition to the solvent including at least one hydroxy functional group. The second solvent may be a non-water miscible solvent. Suitable such solvents may be selected from one or more of hydrocarbon oils, alkylcarbonates, synthetic and vegetable oils, essential oils, oily esters, silicon oils or perfumes.

In such embodiments, the ratio of solvent including at least one hydroxy functional group to the second solvent (non-water miscible solvent) may be from 100:1 to 1:5, suitably from 10:1 to 1:2, from 5:1 to 1:1 or from 3:1 to 1:1.

Component (e) comprises water.

The water content of the composition is less than 20 wt %.

It is preferred that water is present in the composition.

Preferably the composition comprises at least 0.1 wt %, preferably at least 0.5 wt %, suitably at least 1 wt % of water.

In preferred embodiments the composition comprises from 5 to 20 wt % water.

In some embodiments the composition comprises less than 19 wt % water, for example, less than 18 wt % or less than 17 wt %.

For the avoidance of doubt, wherein amounts of components in a composition are described in wt %, this means the weight percentage of the specified component in relation to the whole composition referred to, for example the whole solid detergent composition.

Component (a) is preferably present in the composition of the present invention in an amount of from 0.1 to 50 wt %, preferably from 1 to 40 wt %, more preferably from 5 to 30 wt %, for example from 10 to 25 wt % or from 15 to 23 wt %.

Component (b) is preferably present in the composition of the present invention in an amount of from 0.1 to 50 wt %, preferably from 1 to 40 wt %, more preferably from 3 to 35 wt %, for example from 5 to 32 wt % or 6 to 30 wt %.

Component (c) is preferably present in the composition of the present invention in an amount of from 0.1 to 50 wt %, preferably from 1 to 40 wt %, more preferably from 2 to 30 wt %, for example from 5 to 25 wt % or from 8 to 18 wt %.

Component (d) is preferably present in the composition of the present invention in an amount of from 0.1 to 60 wt %, preferably from 1 to 50 wt %, more preferably from 5 to 40 wt %, for example from 8 to 38 wt % or 10 to 35 wt %.

Preferably the solid detergent composition of the first aspect of the present invention comprises:
(a) from 5 to 30 wt %, preferably from 10 to 25 wt % of a salt of an amine and a fatty acid wherein at least 50% of the fatty acid molecules have at least 16 carbon atoms;
(b) from 1 to 40 wt %, preferably from 5 to 32 wt % of a nitrogen containing surfactant;
(c) from 2 to 30 wt %, preferably from 5 to 25 wt % of an anionic surfactant;
(d) from 5 to 40 wt % preferably from 8 to 38 wt % of a solvent including at least one hydroxy functional group; and
(e) less than 20 wt %, preferably 5 to 20 wt %, more preferably 6 to 18 wt % water.

In preferred embodiments the composition of the present invention comprises:
(a) the salt of a monoalkanolamine having 3 to 6 carbon atoms and a mixture of fatty acids wherein at least 80% of the fatty acid molecules are C16 to C18 fatty acids;
(b) a nitrogen containing surfactant selected from alkanolamides, amine oxides, betaines and mixtures thereof;
(c) one or more anionic surfactants selected from alkyl or alkenyl sulphates, alkyl or alkenyl ether sulphates, alkyl sulphonates, alkenyl sulphonates, hydroxyalkyl sulphonates and taurates;
(d) a solvent selected from polyhydric alcohols, alkoxy alcohols, aryloxy alcohols and mixtures thereof; and
(e) water.

In some embodiments the composition of the present invention comprises:
(a) the salt of a monoalkanolamine having 3 to 6 carbon atoms and a mixture of fatty acids wherein at least 80% of the fatty acid molecules are C16 to C18 fatty acids;
(b) a nitrogen containing surfactant selected from alkanolamides, amine oxides, betaines and mixtures thereof;
(c) one or more anionic surfactants selected from alkyl or alkenyl sulphates, alkyl or alkenyl ether sulphates, alkyl sulphonates, alkenyl sulphonates and hydroxyalkyl sulphonates;
(d) a solvent selected from polyhydric alcohols, alkoxy alcohols and mixtures thereof; and
(e) water.

In preferred embodiments the composition of the present invention comprises:
(a) the salt of a monoalkanolamine having 3 to 6 carbon atoms and a mixture of fatty acids wherein at least 80% of the fatty acid molecules are C16 to C18 fatty acids;
(b) a nitrogen containing surfactant selected from alkanolamides, amine oxides and amphoteric or zwitterionic compounds, or mixtures thereof;
(c) one or more anionic surfactants selected from alkyl or alkenyl sulphates, alkyl or alkenyl ether sulphates, alkyl sulphonates, alkenyl sulphonates, hydroxyalkyl sulphonates and taurates;
(d) a solvent selected from polyhydric alcohols, alkoxy alcohols, aryloxy alcohols and mixtures thereof; and
(e) water.

In some embodiments the composition of the present invention comprises:
(a) the salt of a monoalkanolamine having 3 to 6 carbon atoms and a mixture of fatty acids wherein at least 80% of the fatty acid molecules are C16 to C18 fatty acids;
(b) a nitrogen containing surfactant selected from alkanolamides, amine oxides and amphoteric or zwitterionic compounds, or mixtures thereof;
(c) one or more anionic surfactants selected from alkyl or alkenyl sulphates, alkyl or alkenyl ether sulphates, alkyl sulphonates, alkenyl sulphonates and hydroxyalkyl sulphonates;
(d) a solvent selected from polyhydric alcohols, alkoxy alcohols and mixtures thereof; and
(e) water.

In preferred embodiments the composition of the present invention comprises:
(a) the salt of monoisopropanolamine and a mixture of fatty acids wherein at least 80% of the fatty acid molecules are C16 to C18 fatty acids;
(b) a nitrogen containing surfactant selected from cocoamidopropyl betaine and amidopropyl betaines prepared from C8 and/or C10 fatty acids;
(c) one or more anionic surfactants selected from alkyl or alkenyl sulphates, alkyl or alkenyl ether sulphates, alkyl sulphonates, alkenyl sulphonates, hydroxyalkyl sulphonates and taurates;
(d) a solvent selected from polyhydric alcohols, alkoxy alcohols, aryloxy alcohols and mixtures thereof; and
(e) water.

In some embodiments the composition of the present invention comprises:
(a) the salt of monoisopropanolamine and a mixture of fatty acids wherein at least 80% of the fatty acid molecules are C16 to C18 fatty acids;
(b) a nitrogen containing surfactant selected from cocoamidopropyl betaine and amidopropyl betaines prepared from C8 and/or C10 fatty acids;
(c) one or more anionic surfactants selected from alkyl or alkenyl sulphates, alkyl or alkenyl ether sulphates, alkyl sulphonates, alkenyl sulphonates and hydroxyalkyl sulphonates;
(d) a solvent selected from polyhydric alcohols, alkoxy alcohols, and mixtures thereof; and
(e) water.

In preferred embodiments the composition of the present invention comprises:
(a) from 5 to 30 wt %, preferably from 10 to 25 wt % of the salt of a monoalkanolamine having 3 to 6 carbon atoms and a mixture of fatty acids wherein at least 80% of the fatty acid molecules are C16 to C18 fatty acids;
(b) from 1 to 40 wt %, preferably from 5 to 32 wt % of a nitrogen containing surfactant selected from alkanolamides, amine oxides, betaines and mixtures thereof;
(c) from 2 to 30 wt %, preferably from 5 to 25 wt % of one or more anionic surfactants selected from alkyl or alkenyl sulphates, alkyl or alkenyl ether sulphates, alkyl sulphonates, alkenyl sulphonates, hydroxyalkyl sulphonates and taurates;
(d) from 5 to 40 wt % preferably from 8 to 38 wt % of a solvent selected from polyhydric alcohols, alkoxy alcohols, aryloxy alcohols and mixtures thereof; and
(e) less than 20 wt %, preferably 5 to 20 wt %, more preferably 6 to 18 wt % water.

In some embodiments the composition of the present invention comprises:
(a) from 5 to 30 wt %, preferably from 10 to 25 wt % of the salt of a monoalkanolamine having 3 to 6 carbon atoms and a mixture of fatty acids wherein at least 80% of the fatty acid molecules are C16 to C18 fatty acids;
(b) from 1 to 40 wt %, preferably from 5 to 32 wt % of a nitrogen containing surfactant selected from alkanolamides, amine oxides, betaines and mixtures thereof;
(c) from 2 to 30 wt %, preferably from 5 to 25 wt % of one or more anionic surfactants selected from alkyl or alkenyl sulphates, alkyl or alkenyl ether sulphates, alkyl sulphonates, alkenyl sulphonates, hydroxyalkyl sulphonates;
(d) from 5 to 40 wt % preferably from 8 to 38 wt % of a solvent selected from polyhydric alcohols, alkoxy alcohols, and mixtures thereof; and
(e) less than 20 wt %, preferably 5 to 20 wt %, more preferably 6 to 18 wt % water.

In preferred embodiments the composition of the present invention comprises:
(a) from 5 to 30 wt %, preferably from 10 to 25 wt % of the salt of monoisopropanolamine and a mixture of fatty acids wherein at least 80% of the fatty acid molecules are C16 to C18 fatty acids;
(b) from 1 to 40 wt %, preferably from 5 to 32 wt % of a nitrogen containing surfactant selected from cocoamidopropyl betaine and amidopropyl betaines prepared from C8 and/or C10 fatty acids;
(c) from 2 to 30 wt %, preferably from 5 to 25 wt % of one or more anionic surfactants selected from alkyl or alkenyl sulphates, alkyl or alkenyl ether sulphates, alkyl sulphonates, alkenyl sulphonates, hydroxyalkyl sulphonates and taurates;
(d) from 5 to 40 wt % preferably from 8 to 38 wt % of a solvent selected from polyhydric alcohols, alkoxy alcohols, aryloxy alcohols and mixtures thereof; and
(e) less than 20 wt %, preferably 5 to 20 wt %, more preferably 6 to 18 wt % water.

In some embodiments the composition of the present invention comprises:
(a) from 5 to 30 wt %, preferably from 10 to 25 wt % of the salt of monoisopropanolamine and a mixture of fatty acids wherein at least 80% of the fatty acid molecules are C16 to C18 fatty acids;
(b) from 1 to 40 wt %, preferably from 5 to 32 wt % of a nitrogen containing surfactant selected from cocoamidopropyl betaine and amidopropyl betaines prepared from C8 and/or C10 fatty acids;
(c) from 2 to 30 wt %, preferably from 5 to 25 wt % of one or more anionic surfactants selected from alkyl or alkenyl sulphates, alkyl or alkenyl ether sulphates, alkyl sulphonates, alkenyl sulphonates and hydroxyalkyl sulphonates;
(d) from 5 to 40 wt % preferably from 8 to 38 wt % of a solvent selected from polyhydric alcohols, alkoxy alcohols, and mixtures thereof; and
(e) less than 20 wt %, preferably 5 to 20 wt %, more preferably 6 to 18 wt % water.

The solid detergent composition of this first aspect may be suitable for any one or more of the following uses: toilet care, automatic dishwashing, manual dishwashing, laundry, fabric care, kitchen care, carpet cleaning, air fresheners, vehicle care, polishing products, machine cleaning and maintenance, pesticides, insecticides, fungicides, herbicides, oilfield chemical applications, marine applications, personal care and institutional/industrial cleaning.

In some preferred embodiments the composition of the first aspect further comprises (f) a non-ionic surfactant.

Suitable non-ionic surfactants will be known to the person skilled in the art.

Suitable non-ionic surfactants include alkyl alkoxylates, alkenyl alkoxylates, C6-C22 alcohol condensates with ethylene oxide/propylene oxide block polymers; C14-C22 mid-chain branched alcohols, C14-C22 mid-chain branched alkyl alkoxylate, alkylpolysaccharides, (for example alkylpolyglycosides), methylester ethoxylates, polyhydroxy fatty acid amides, ether capped poly(oxyalkylated) alcohol surfactants, acyl polyethoxylated-glycerol esters (for example cocoyl POE-glycerol esters) and mixtures thereof.

In some embodiments, the non-ionic surfactant may be a condensation product of straight or branched chain fatty alcohols containing between 6 and 22 carbon atoms with between 4 and 30 moles of ethylene oxide having a HLB between 8 and 15.

Preferably a non-ionic surfactant comprises an alkoxylated compound. Preferably the alkoxylated non-ionic surfactants comprises at least two alkoxy residues, preferably at least two ethoxy residues.

Suitable alkoxylated non-ionic surfactants include any compound comprising one or more alkylene oxide residue and a hydrophobic group. Preferred non-ionic surfactants are compounds which include one or more ethylene oxide and/or propylene oxide residue and a hydrophobic group. Suitable non-ionic surfactants may be formed by the reaction of aliphatic alcohols, acids or amides with alkylene oxides. Preferably the hydrophobic group comprises a hydrocarbon chain having at least 4 carbon atoms, preferably at least 5 carbon atoms, more preferably at least 6 carbon atoms. Preferably the hydrophobic group comprises from 6 to 30 carbon atoms, more preferably from 6 to 21 carbon atoms, most preferably from 8 to 18 carbon atoms. Preferably the hydrophobic group is an alkyl group. The non-ionic surfactant component (f) may include more than one hydrophobic residue.

Preferred non-ionic surfactants for use herein are alkoxylated alcohols prepared from a C8 to C20 alcohol and 2 to 16 equivalents of ethylene oxide.

Especially preferred non-ionic surfactants are alkoxylated alcohols are C12-16 or C12-18 alcohols ethoxylated with 7 equivalents of ethylene oxide or C10 alcohol ethoxylated with 5 equivalents of ethylene oxide.

In some embodiments, the nitrogen containing surfactant of component (b) may be provided by a non-ionic surfactant which is a nitrogen containing surfactant. For the avoidance of doubt, component (f), when present, is present in the composition in addition to the nitrogen containing detergents of component (b).

Component (f) is preferably present in the composition of the present invention in an amount of from 1 to 30 wt %, preferably 2 to 20 wt %, more preferably 5 to 15 wt %.

The composition of the present invention may optionally comprise one or more further components.

Suitable further components may include any components commonly used in detergent compositions.

Suitable additional components for use in automatic dishwashing compositions include cationic surfactants, zwitterionic surfactants, amphoteric surfactants, enzymes, organic solvents, glass corrosion inhibitors, corrosion inhibitors, scents, perfume carriers, chelating agents, enzymes, bleaching agents, bleach activators, biocides, rinse aids, dyes, pigments, fragrances, glass care agents, pH adjusting agents, builders (preferably silicates or zeolites), peroxide based compounds (especially hydrogen peroxide) chlorine bleaches, perborate compounds, bleach activators and catalysts.

When the composition of the first aspect is an automatic dishwashing composition it may include any of these components.

Preferably the composition of the first aspect of the present invention is a laundry detergent composition.

Suitable additional components for inclusion in laundry compositions will be known to the person skilled in the art and include chelating agents, builders, bleaching agents, bleach activators, pigments, dispersants, polymeric dispersing agents, dyes, dye transfer inhibitors, fragrances, fragrance delivery systems, enzymes, enzyme stabilizers, biocides, probiotics, preservatives, pH adjusting agents, phosphates, silicates, zeolites, peroxide based compounds (especially hydrogen peroxide, chlorine bleaches), perborate compounds, percarbonate compounds, bleach activators and catalysts, cationic surfactants, redeposition additives, brighteners, sud suppressors, fabric softeners and hydrotropes.

In some preferred embodiments the composition of the first aspect comprises an anti-redeposition agent. These compounds help maintain salts in solution during the wash cycle machine.

Suitable anti-redeposition agents will be known to the person skilled in the art. Such components often comprise polyimides. One suitable compound is sold under the trade mark Sokalan HP20 and is an ethoxylated polyethylene polyimine.

Anti-redeposition agents are typically included in an amount of from 0.1 to 2 wt %.

Preferably the composition or the first aspect comprises a chelating agent. Suitable chelating agents will be known to the person skilled in the art.

Suitable chelating agents include ethylenediamine-N,N′-disuccinic acid, methylglycinediacetic acid, glutamic acid N,N-diacetic acid, imino disuccinic acid, diethylene triamine pentaacetic acid, ethylenediamine tetraacetic acid, diethylenetriamine penta methylene phosphonic acid, etidronic acid, citric acid and anions, salts and mixtures thereof.

Preferred chelating agents for use herein are phosphonate chelating agents.

Chelating agents are typically included in an amount of from 0.1 to 2 wt %.

Other preferred components for inclusion in the compositions of the first aspect include probiotics, enzymes, dye transfer inhibitors and wash performance boosting polymers. Wash performance boosting polymers are known to those skilled in the art. For example, the composition of the first aspect may comprise polyacrylates, polycarboxylates, cellulose derivatives, polyesters based on terephthalic acid, ethylene/propylene glycol-based polymers, poly(vinylpyrrolidone (PVP), poly(vinylpyridine N-oxide) (PVP-NO), poly(vinylpyridine betaine), biodegradable polymeric dispersants (for example polyamino acid polymers such as polyaspartate and polysaccharides such as oxidized starch), poly(vinyl alcohol), polyalkylene glycol and copolymers of alkylene oxide and vinyl acetate, modified ethoxylated urethane or multifunctional polyethylene imine.

Dye transfer inhibitors are also known to those skilled in the art.

The compositions of the present invention are solids. By this we mean that the compositions are solid at the temperatures encountered during normal storage and/or prior to use of the compositions, for example ambient temperature or room temperature (for example between 15° C. and 25° C., or between 18° C. and 22° C.). Preferably the compositions are solid at temperatures below 50° C. The solid detergent composition preferably has a melting point of at least 50° C.

In preferred embodiments the detergent composition of the first aspect is provided in unit dose form.

Preferably the present invention provides a solid laundry composition in unit dose form.

The composition of the present invention may provide a number of advantages over compositions of the prior art.

The compositions of the present invention are highly effective detergents and have a low water content. They therefore comprise high levels of active ingredients. This allows small unit doses to be provided.

Preferably each unit dose has a mass of from 5 to 100 g, preferably from 5 to 75 g, more preferably from 10 to 50 g, suitably from 15 to 40 g, preferably from 20 to 30 g.

Preferably the compositions of the present invention are sufficiently non-irritating and non-toxic that they can be directly handled by the user. Thus in preferred embodiments the unit doses of the present invention do not comprise any individual coating, encapsulation or wrapping.

The unit dose forms may be provided in plastic free packaging.

In some embodiments, the unit dose form does not comprise a powder. In such embodiments, the unit dose form suitably consists essentially or consists of the solid detergent composition of the first aspect. Suitably such a unit dose form is suitably completely transparent.

In some embodiments, the unit dose form comprises the solid detergent composition of the first aspect and a second composition.

Preferably the solid detergent compositions of the present inventions are provided as a solid block of material of substantially homogeneous consistency.

In some especially preferred embodiments, the compositions of the present invention are transparent. By this we mean that light passes through the material and it is possible to look through the material and observe objects on the other side of the material.

Transparency may suitably be measured using the test described in example 4.

The provision of transparent compositions is highly attractive to consumers.

The compositions of the present invention preferably have favourable dissolution properties. It is particularly important that unit doses quickly and fully dissolve at the start of the wash and do not become stuck in one portion of a machine.

The dissolution rate of the compositions of the present invention may be measured using the method described in example 3.

Preferably the compositions of the present invention have a dissolution rate of at least 0.5 g/min as measured by the method of example 3, preferably at least 0.6 g/min, more preferably at least 0.7 g/min.

In order to obtain the desirably homogeneous and preferably transparent compositions of the present invention the compositions are preferably prepared from a melt.

Preferably the melting point of the compositions of the present invention is at least 45° C., preferably at least 50° C.

Preferably the melting point of the composition of the first aspect is from 45 to 70° C., more preferably from 50 to 65° C.

One way in which the melting point of the compositions of the present invention can be measured is described in example 5.

In preferred embodiments, the solid detergent composition of this first aspect is transparent, has a dissolution rate of at least 0.5 g/min as measured by the method of example 3 and has a melting point of from 45 to 70° C.

In especially preferred embodiments, the solid detergent composition of this first aspect is transparent, has a dissolution rate of at least 0.7 g/min as measured by the method of example 3 and has a melting point of from 50 to 65° C.

According to a second aspect of the present invention there is provided a method of manufacturing a solid detergent composition, the method comprising the steps of:
(i) preparing a molten composition comprising at least the following components:
   (a) a salt of an amine and a fatty acid wherein at least 50% of the fatty acid molecules have at least 16 carbon atoms;
   (b) at least one nitrogen containing surfactant;
   (c) at least one anionic surfactant;
   (d) at least one solvent including at least one hydroxy functional group; and
   (e) up to 20 wt % water;
and
(ii) shaping and/or cooling the composition obtained in step (i).

Step (i) involves providing a molten composition comprising components (a) to (e). The molten composition may optionally comprise one or more further components, as defined in relation to the first aspect. Preferably the composition further comprises (f) a non-ionic surfactant.

Preferred features of the second aspect are as defined in relation to the first aspect.

Step (i) involves providing a composition in molten form by combining components (a) to (e).

Components (a) to (e) may be added in any order.

In some embodiments one or more components may be melted and then further components added to the mixture.

In some embodiments, liquid components are mixed together first followed by addition of the solid components.

Component (a) may be added in step (i) as a salt or it may be formed in situ by separate addition of the fatty acid and the amine. The formation of the salt of component (a) may not convert all of the fatty acid and/or all of the amine to the salt. Therefore component (a) may contain some free fatty acid and/or some free amine. Preferably all or substantially all of the fatty acid is converted to the salt with the amine. Preferably all or substantially all of the amine is converted to the salt with the fatty acid.

In preferred embodiments step (i) of the method of the second aspect involves:
(p) melting component (b);
(q) adding component (c) whilst heating and mixing; and
(r) adding component (a) to the mixture obtained following steps (p) and (q).

Components (d) and (e) may be added at any stage and are typically included with one of the other components. Commonly raw ingredients may include an amount of water or solvent.

Other components, including further surfactants, dyes, fragrances, chelating agents and active anti-redeposition agents, may be added at any stage.

In preferred embodiments in which a non-ionic surfactant (f) is included, this is preferably added during step (p) or step (q).

Throughout step (i) the mixture is preferably heated, preferably to a temperature of at least 60° C., preferably at least 65° C., for example to a temperature of 70 to 80° C. or 70 to 75° C.

Step (i) is preferably completed when a homogeneous mixture is obtained.

Step (ii) involves shaping and/or cooling the composition obtained in step (i).

Step (ii) preferably involves forming the composition into unit doses.

In some embodiments step (ii) may involve pouring the molten composition into moulds. In such embodiments this is preferably carried out at a temperature of at least 65° C., preferably at least 70° C.

After pouring into the moulds, the composition may be actively or passively cooled.

In preferred embodiments the moulds are sized to provide unit doses.

In some embodiments step (ii) may involve contacting the composition provided in step (i) with a cooled belt or may involve moving the composition provided in step (i) to a cooled chamber.

The composition may be dosed into the belt to provide unit dose tablets or poured to provide a strip or block which is subsequently cut into unit doses.

According to a third aspect of the present invention there is provided a packaged detergent product comprising a container and a solid detergent composition, the solid detergent composition comprising:
(a) a salt of an amine and a fatty acid wherein at least 50% of the fatty acid molecules have at least 16 carbon atoms;
(b) at least one nitrogen containing surfactant;
(c) at least one anionic surfactant;
(d) a solvent including at least one hydroxy functional group; and
(e) up to 20 wt % water.

Preferred features of the third aspect are as defined in relation to the first and second aspects.

Preferably the packaged detergent product comprises a container and a plurality of unit doses of the detergent composition.

Preferably the unit doses are not individually wrapped. Preferably they are in homogeneous form. Preferably they are not coated or encapsulated.

Advantageously the container may be made of cardboard. It may be plastic free.

According to a fourth aspect of the present invention there is provided a method of laundering items, the method comprising: loading the items into a washing machine, adding a solid detergent into the washing machine, and running a wash cycle of the washing machine, wherein the solid detergent composition comprises:
(a) a salt of an amine and a fatty acid wherein at least 50% of the fatty acid molecules have at least 16 carbon atoms;
(b) at least one nitrogen containing surfactant;
(c) at least one anionic surfactant;
(d) a solvent including at least one hydroxy functional group; and
(e) up to 20 wt % water.

Preferably the composition is provided in unit dose form, preferably as a transparent homogeneous solid.

Preferred features of the fourth aspect are as defined in relation to the first, second and third aspects.

According to a fifth aspect of the present invention, there is provided a use of a solid detergent composition in toilet care, automatic dishwashing, manual dishwashing, laundry, fabric care, kitchen care, carpet cleaning, air fresheners, vehicle care, polishing products, machine cleaning and maintenance, pesticides, insecticides, fungicides, herbicides, oilfield chemical applications, marine applications, personal care or institutional/industrial cleaning;
the solid detergent composition comprising:
   (a) a salt of an amine and a fatty acid wherein at least 50% of the fatty acid molecules have at least 16 carbon atoms;
   (b) at least one nitrogen containing surfactant;
   (c) at least one anionic surfactant;
   (d) a solvent including at least one hydroxy functional group; and
   (e) water;
wherein water makes up no more than 20 wt % of the total detergent composition.

The solid detergent composition may have any of the suitable features and advantages described in relation to the first, second and third aspects.

Preferably this fifth aspect involves use of the solid detergent composition in household cleaning applications, especially in laundry.

Any feature of any aspect may be combined with any other aspect as appropriate

The invention will now be further defined with reference to the following non-limiting examples.

### EXAMPLE 1

A composition of the present invention was prepared as follows:

A blend of C₈-C₁₀ amidopropyl betaine, propylene glycol and water was admixed with dipropylene glycol and an ethoxylated polyethylene polyimine. The mixture was stirred and heated to 75 to 80° C. An alcohol ethoxylate (C₁₂-C₁₈ alcohol and 7EO) was added at 70° C., followed by the slow addition of sodium laureth-1-sulfate. Whilst maintaining a temperature of at least 70° C., monoisopropylamine and a fatty acid (1:1 C₁₆: C₁₈) were added. Perfume and colourants were added and mixing continued until homogenization was achieved. The mixture was discharged from the vessel at temperature of at least 75° C. and poured into moulds.

### EXAMPLE 2

Further compositions of the present invention were prepared using a procedure analogous to that described in example 1.

The details of the compositions are provided in table 1 wherein “Comp.” denotes a comparative example:

TABLE 1
COMPOSITION

| | | 2 | | | | 6 | | |
|---|---|---|---|---|---|---|---|---|
| Component (wt %) | 1 | (Comp.) | 3 | 4 | 5 | (Comp.) | 7 | 8 |
| Cocamide MIPA | 12.7 | 12.7 | | | | | | |
| SLES | 12.8 | 13 | 14 | 14 | 14 | 14 | 9.8 | 15.75 |
| Sodium methyl cocoyl | | | | | | | | |
| taurate (de-salted) | | | | | | | | |
| C16-C18 FATTY ACID | 12.8 | 12.8 | 14 | 14 | 14 | 14 | 14 | 15.7 |
| C12-16 Amine oxide | 7.1 | 7 | | | | | | |
| C10 + 5 EO | 9.4 | 9.4 | | | | | | |
| C10 amidopropyl | | | 7.8 | 7.8 | 3.9 | 3.9 | 3.9 | 4.42 |
| betaine | | | | | | | | |
| C8 amidopropyl betaine | | | | | 4.56 | 4.56 | 4.56 | 5.14 |
| C12-18 + 7 EO | | | 11 | 11 | 11 | 11 | 11 | |
| C8-10 amidopropyl | | | | | | | | |
| betaine | | | | | | | | |
| Monoisopropanolamine | 3.6 | 3.6 | 3.9 | 3.9 | 3.9 | 3.9 | 3.9 | 4.4 |
| C12-18 amidopropyl | | | | | | | | |
| betaine | | | | | | | | |
| Propylene Glycol | 9.4 | | 29.4 | 3.4 | 5.6 | | 5.6 | 4.16 |
| Water | 8.27 | 22.6 | 14.7 | 14.7 | 14.7 | 27.74 | 17.6 | 16.6 |
| Dipropylene Glycol | 21.2 | 17 | | | 26.1 | 19.4 | 26.1 | 29.3 |
| 2-methyl pentanediol | | | | | | | | |
| 2-phenoxyethanol | | | | | | | | |
| 3-methoxy-3-methyl-1- | | | | 26 | | | | |
| butanol (MMB) | | | | | | | | |
| Phosphonate | 0.8 | | 1 | 1 | 1 | | | 1.1 |
| Poly-imide | 0.8 | 1.28 | 0.8 | 0.8 | 0.8 | | 1.6 | 0.8 |
| Others (impurities) | to 100 | to 100 | to 100 | to 100 | to 100 | to 100 | to 100 | to 100 |

COMPOSITION

| | | | | 12 | | | | |
|---|---|---|---|---|---|---|---|---|
| Component (wt %) | 9 | 10 | 11 | (Comp.) | 13 | 14 | 15 | 16 |
| Cocamide MIPA | 14.2 | 13 | 6.38 | 6.38 | | | | 5.43 |
| SLES | 14.28 | 13 | 13.4 | 13.4 | 9.8 | 9.8 | 9.8 | |
| Sodium methyl cocoyl | | | | | | | | 8.66 |
| taurate (de-salted) | | | | | | | | |
| C16-C18 FATTY ACID | 14.2 | 13 | 13.4 | 13.4 | 14 | 14 | 14 | 13.4 |
| C12-16 Amine oxide | 8 | 4.9 | 3.56 | 3.56 | | | | 3.63 |
| C10 + 5 EO | 10 | 9 | 4.72 | 4.72 | | | | 4.7 |
| C10 amidopropyl | | | | | 3.9 | 3.9 | | 3.03 |
| betaine | | | | | | | | |
| C8 amidopropyl betaine | | | | | 4.56 | 4.56 | | 3.54 |
| C12-18 + 7 EO | | | 5.5 | 5.5 | 11 | 11 | 11 | 5.5 |
| C8-10 amidopropyl | | 2.8 | 4.2 | 4.2 | | | | |
| betaine | | | | | | | | |
| Monoisopropanolamine | 4 | 3.7 | 3.75 | 3.75 | 3.9 | 3.9 | 3.9 | 3.75 |
| C12-18 amidopropyl | | | | | | | 8.5 | |
| betaine | | | | | | | | |
| Propylene Glycol | 10 | 6.8 | 7.52 | | 5.6 | 5.6 | 5.6 | 9.05 |
| Water | 9.87 | 10.3 | 10.8 | 25.1 | 17.6 | 17.6 | 17.6 | 11.7 |
| Dipropylene Glycol | 12.4 | 21.6 | 23.65 | 18.35 | | | | 23.65 |
| 2-methyl pentanediol | | | | | | 13.05 | | |
| 2-phenoxyethanol | | | | | 26.1 | 13.05 | 26.1 | |
| 3-methoxy-3-methyl-1- | | | | | | | | |
| butanol (MMB) | | | | | | | | |
| Phosphonate | — | — | | | | | | |
| Poly-imide | 1.44 | 1.3 | 1.44 | 1.44 | 1.6 | 1.6 | 1.6 | 1.44 |
| Others (impurities) | to 100 | to 100 | to 100 | to 100 | to 100 | to 100 | to 100 | to 100 |

The abbreviations used in Table 1 are defined below in Table 2.

TABLE 2

| Component | Chemical Names |
|---|---|
| Cocamide MIPA | Coconut Monoisopropanolamide |
| SLES | Sodium lauryl ether sulfate |
| C16-C18 FATTY | Cetyl-stearyl acid |
| ACID | |
| C12-16 Amine oxide | Lauryl dimethylamine Oxide or Lauramine |
| | oxide |
| C10 + 5 EO | C10 fatty alcohol ethoxylated with 5 |
| | moles of ethylene oxide |
| C10 amidopropyl | Decylamidopropyl betaine |
| betaine | |
| C8 amidopropyl | Octylamidopropyl betaine |
| betaine | |
| C12-18 + 7 EO | C12-18 fatty alcohol ethoxylated with 7 |
| | moles of ethylene oxide |
| C8-10 amidopropyl | Blend of Octylamidopropyl betaine and |
| betaine | Decylamidopropyl betaine |
| C12-18 amidopropyl | Cocamidopropyl betaine |
| betaine | |
| Phosphonate | diethylenetriamine penta (methylenephosphonic) |
| | acid, sodium salt - DTPMP |
| Poly-imide | ethoxylated polyethylene polyimine |

### EXAMPLE 3

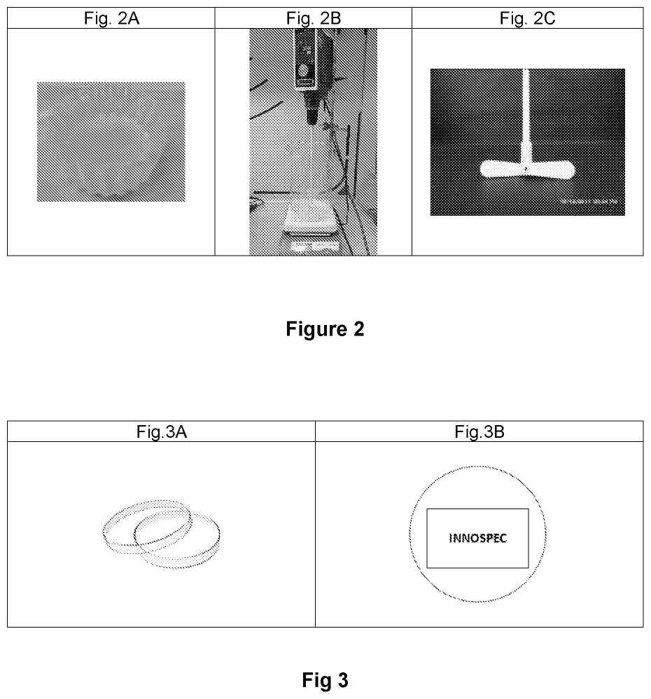

The dissolution rate of the compositions was measured using the following method, with reference to FIGS. 2A, B and C:

### Apparatus

5000 ml beaker.
Lab Stirrer with variable speed.
Stirrer 9.5 cm length impeller (FIG. 2c).
Hot plate with Temperature probe
Stopwatch
Oven
Distilled Water
Silicone mould able to contain a ˜ 15 g sample of the test compositions

### Analytical Procedure

˜ 15 grams of the molten test composition (70-75° C.) was poured into a silicone mould. The exact weight dispensed was recorded (W1)
The composition was cooled to room temperature (i.e. between 18° C. and 22° C.) in the silicone mould and allowed to stand (solidify) for 60 minutes (see FIG. 2A)
A 5000 mL glass beaker was filled with deionized water (4000 mL) and placed on a hot plate. A temperature probe was immersed in the water (FIG. 2B)
The water was heated to 30° C.; this temperature was maintained throughout the analysis
Overhead stirring was applied to the glass beaker contents using an impeller (FIG. 2C) with stirrer speed 300 RPM
When the temperature had stabilized at 30° C., the moulded test composition was added and a stopwatch was immediately started.
When the sample had completely dissolved the stopwatch was stopped and the dissolution time in seconds was noted (T1).
The dissolution rate (g/min) was calculated from W1 and T1.
Use an electric torch to highlight the visibility of the sample in the beaker.

### EXAMPLE 4

The transparency of the composition was assessed by the following method:

### Apparatus

Transparent Petri capsules, inner Ø ca.50 mm, height ca. 12 mm. (FIG. 3A)
Pasteur pipette.
Technical balance.
White paper with printed boldface type of 14 point size. (FIG. 3B)

### Analytical Procedure.

The test composition was melted at 70-75° C.
A sample of the molten test composition (14.00 g) was weighed into the transparent Petri capsule, which was then covered with the cap.
The sample was cooled to 25° C. and stood for at least for 60 minutes. The cap was removed.
The Petri capsule was placed on the white paper, on top the printed boldface type.
The clarity of the boldface type was visually assessed as set out below

### Calculation of Results

The test composition was defined as “transparent” when the 14 point boldface type could be clearly read through a 6.35 mm section of material (corresponding to 14.00 g of test sample in the transparent Petri capsule as described above)

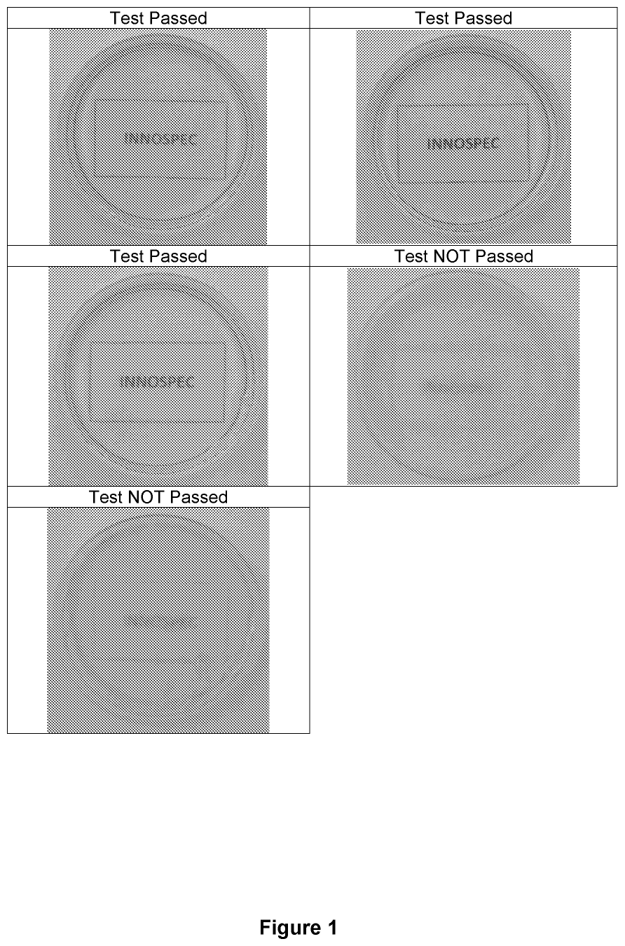

FIG. 1 shows some illustrations of test compositions which have passed or failed this test.

### EXAMPLE 5

The melting point of the test compositions was measured by the following method:

### Apparatus

Water bath with thermoregulation

### Analytical Procedure

A sample of the test composition (˜ 50 g) was weighted into a transparent glass or plastic container, and allowed to warm to room temperature
The bath temperature was set to a starting temperature, typically ˜ 45° C. The starting temperature was recorded
Upon reaching the bath temperature, the container containing the sample was immersed and held at the starting temperature for 30 minutes
The bath temperature was increased in 0.5° C. increments, holding at each temperature for 15 minutes. The experiment was ended when the coexistence of liquid and solid phases was visually observed, at the end of a 15 minute hold period
The melting point was defined as (T−0.4° C.) where T=bath set temperature for the experiment end point

### EXAMPLE 6

The composition of Table 1 were tested for dissolution rate, transparency and melting point using the procedures of examples 3 to 5. The results are shown in Table 3.

TABLE 3

| | | Melting | Dissolution | |
|---|---|---|---|---|
| | Form/ | point | rate | |
| Composition | appearance | (° C.) | (g/min) | Transparent? |
| 1 | Solid | 51 | 0.79 | yes |
| 2 | Separates | <40 | 0.67 | yes |
| (comparative) | | | | |
| 3 | Solid | 54 | 0.72 | yes |
| 4 | Solid | 60-65 | 0.89 | yes |
| 5 | Solid | 61 | 0.87 | yes |
| 6 | Solid | 46 | 0.73 | yes |
| (comparative) | | | | |
| 7 | Solid | 53 | 0.90 | yes |
| 8 | Solid | 64 | 0.94 | yes |
| 9 | Solid | 55 | 0.77 | yes |
| 10 | Solid | 59 | 0.72 | yes |
| 11 | Solid | 60 | 0.7 | yes |
| 12 | Solid | 40 | 0.57 | yes |
| (comparative) | | | | |
| 13 | Solid | 50 | 0.97 | yes |
| 14 | Solid | 50 | 0.96 | yes |
| 15 | Solid | 50 | 0.95 | yes |
| 16 | Solid | 55 | 0.84 | yes |

1. A solid detergent composition comprising:
(a) a salt of an amine and a fatty acid wherein at least 50% of the fatty acid molecules have at least 16 carbon atoms;
(b) at least one nitrogen containing surfactant;
(c) at least one anionic surfactant;
(d) at least one solvent including at least one hydroxy functional group; and
(e) water;
wherein the water makes up no more than 20 wt % of the total solid detergent composition.

2. The solid detergent composition according to claim 1, wherein the component (a) comprises the salt of a monoalkanolamine having 3 to 6 carbon atoms and a mixture of fatty acids wherein at least 80% of the fatty acid molecules are C₁₆ to C₁₈ fatty acids.

3. The solid detergent composition according to claim 1, wherein the component (b) comprises a nitrogen containing surfactant selected from the group consisting of alkanolamides, amine oxides, betaines and mixtures thereof.

4. The solid detergent composition according to claim 1, wherein the component (c) comprises one or more anionic surfactants selected from the group consisting of alkyl or alkenyl sulphates, alkyl or alkenyl ether sulphates, alkyl sulphonates, alkenyl sulphonates, hydroxyalkyl sulphonates and taurates.

5. The solid detergent composition according to claim 1, wherein the component (d) comprises a solvent selected from the group consisting of polyhydric alcohols, alkoxy alcohols, aryloxy alcohols and mixtures thereof.

6. The solid detergent composition according to claim 1, wherein the component (a) is present in an amount of from 5 to 30 wt %.

7. The solid detergent composition according to claim 1, wherein the component (b) is present in an amount of from 1 to 40 wt %.

8. The solid detergent composition according to claim 1, wherein the component (c) is present in an amount of from 2 to 30 wt %.

9. The solid detergent composition according to claim 1, wherein the component (d) is present in an amount of from 5 to 40 wt %.

10. The solid detergent composition according to claim 1, further comprising a component (f) being a non-ionic surfactant.

11. The solid detergent composition according to claim 1, wherein: the component (a) is the salt of monoisopropanolamine and a mixture of fatty acids wherein at least 80% of the fatty acid molecules are C₁₆ to C₁₈ fatty acids; the component (b) is selected from the group consisting of cocoamidopropyl betaine and amidopropyl betaines prepared from C₈ and/or C₁₀ fatty acids; and the component (c) is one or more anionic surfactants selected from the group consisting of alkyl or alkenyl sulphates, alkyl or alkenyl ether sulphates, alkyl sulphonates, alkenyl sulphonates, hydroxyalkyl sulphonates and taurates.

12. The solid detergent composition according to claim 1, wherein the solid detergent composition is which is provided in a unit dose form.

13. The solid detergent composition according to claim 12, wherein the unit dose has a mass of from 10 to 50 g.

14. The solid detergent composition according to claim 1, wherein the solid detergent composition has a melting point of from 50 to 65° C.

15. The solid detergent composition according to claim 1, wherein the solid detergent composition has a dissolution rate of at least 0.6 g/min.

16. The solid detergent composition according to claim 1, wherein the solid detergent composition is transparent.

17. A method of manufacturing a solid detergent composition, the method comprising the steps of:
(i) preparing a molten composition comprising at least the following components:
(a) a salt of an amine and a fatty acid wherein at least 50% of the fatty acid molecules have at least 16 carbon atoms;
(b) at least one nitrogen containing surfactant;
(c) at least one anionic surfactant;
(d) at least one solvent including at least one hydroxy functional group; and
(e) up to 20 wt % water; and
(ii) shaping and/or cooling the molten composition obtained in step (i).

18. A packaged detergent product comprising a container and a solid detergent composition, the solid detergent composition comprising:
(a) a salt of an amine and a fatty acid wherein at least 50% of the fatty acid molecules have at least 16 carbon atoms;
(b) at least one nitrogen containing surfactant;
(c) at least one anionic surfactant;
(d) a solvent including at least one hydroxy functional group; and
(e) up to 20 wt % water.

19. A packaged detergent product according to claim 18, wherein the container has a plurality of unit doses of the solid detergent composition.

20. A method of laundering items, the method comprising: loading items into a washing machine, adding the solid detergent according to claim 1 into the washing machine, and running a wash cycle of the washing machine.

21. (canceled)
